(19) United States
(12) Patent Application Publication
(10) Pub. No.: US 2023/0076223 A1
(43) Pub. Date: Mar. 9, 2023

(54) Driving Distribution Apparatus of Drone Unit and Method for Controlling the Same

(71) Applicants: Hyundai Motor Company, Seoul (KR); Kia Corporation, Seoul (KR)

(72) Inventors: Yong Lip Kim, Seongnam-si (KR); Nam Woo Lee, Hwaseong-si (KR); Seong Jae Shin, Uiwang-si (KR)

(21) Appl. No.: 17/903,389

(22) Filed: Sep. 6, 2022

(30) Foreign Application Priority Data
Sep. 6, 2021 (KR) 10-2021-0118186

(51) Int. Cl. B60W 30/18; B60W 40/076; B60W 20/14; B60W 10/28; B60W 10/18; B60L 58/30; B60L 58/13

(52) U.S. Cl. CPC B60W 30/18127; B60W 40/076; B60W 20/14; B60W 10/28; B60W 10/18; B60L 58/30; B60L 58/13; B60W 2510/28; B60W 2552/15; B60L 2240/642

(57) ABSTRACT

An embodiment driving distribution apparatus of a drone unit includes a first drone unit located on a first end of a vehicle and a second drone unit located on a second end of the vehicle, wherein each of the first and second drone units includes a sensor unit configured to measure a gradient traveling environment of the vehicle, a driving unit configured to apply a driving force of the vehicle, and a control unit configured to control driving amounts of the first drone unit and the second drone unit based on the gradient traveling environment of the vehicle.

### CROSS-REFERENCE TO RELATED APPLICATIONS

This application claims the benefit of Korean Patent Application No. 10-2021-0118186, filed on Sep. 6, 2021, which application is hereby incorporated herein by reference.

### TECHNICAL FIELD

The present disclosure relates to a driving distribution apparatus of a drone unit and a method for controlling the same.

### BACKGROUND

With the recent increase in interest in the environment, eco-friendly vehicles are being actively developed. As a representative example of the eco-friendly vehicle, there can be electric vehicles (EVs) and hybrid electric vehicles (HEVs).

Further, recently, vehicles to which a method for driving a vehicle using a fuel cell system as an electric vehicle is applied are increasing, and vehicles capable of autonomous traveling in consideration of the surrounding environment of the vehicle are increasing with the fuel cell system.

Further, the electric vehicle (EV) is commonly provided with a driving electric motor, and provided with a regenerative braking system that applies a reverse torque to the electric motor in a braking situation to be operated in a power generation mode, thereby recovering the kinetic energy of the vehicle to charge a battery.

In other words, an eco-friendly vehicle provided with the driving electric motor forms a total braking force obtained by summing hydraulic braking applying a braking torque with a friction force by hydraulic pressure and regenerative braking by a reverse torque of a motor. At this time, it is common for a brake controller to calculate the total braking force required to allow the regenerative braking to be in charge of a certain part, and to allow the hydraulic braking to cover the remaining insufficient braking force.

Further, recently released vehicles have been provided with various traveling convenience functions through electronic equipment. As one of the traveling convenience functions, there can be a hill descent control (HDC).

The hill descent control (HDC) is a convenience function mainly applied to a four-wheel drive (4WD) vehicle suitable for rough road traveling, and independently, automatically controls the brakes of four wheels when traveling on a steep downhill road to enable traveling at a regular speed. Therefore, through this function, the vehicle can stably travel even in poor road conditions.

However, in case of commercial vehicles with multiple autonomous drone units equipped with the fuel cell system and the regenerative braking system, there is the request for varying the driving amount of each of the multiple drone units that provide the driving force of the vehicle depending on a gradient traveling environment.

The above information disclosed in this background section is only for enhancement of understanding of the background of the disclosure and accordingly it may include information that does not form the prior art that is already known to a person of ordinary skill in the art.

Korean Patent Application Laid-Open No. 10-1994-0003773 may provide information related to the subject matter of the present disclosure.

### SUMMARY

The present disclosure relates to a driving distribution apparatus of a drone unit and a method for controlling the same. Particular embodiments relate to an apparatus and a method for controlling the same for controlling a driving amount of each drone unit depending upon a gradient traveling environment in case of a vehicle including multiple drone units, thereby improving durability of a fuel cell system.

Embodiments of the present disclosure may solve problems associated with the related art, and an embodiment of the present disclosure provides an apparatus for controlling driving amounts of multiple drone units in response to a gradient traveling environment.

Further, another embodiment of the present disclosure provides an apparatus for selectively driving a fuel cell system, a high-voltage battery, and a regenerative braking system in the gradient traveling environment.

The embodiments of the present disclosure are not limited to the aforementioned embodiments, and other embodiments not mentioned in the present disclosure can be understood by the following description, and can be known by an exemplary embodiment of the present disclosure more clearly. Further, the embodiments of the present disclosure can be realized by a means described in the claims and a combination thereof.

An apparatus for achieving features of embodiments of the present disclosure includes the following configuration.

As an exemplary embodiment of the present disclosure, a driving distribution apparatus of a drone unit includes a first drone unit located on one end of a commercial vehicle and a second drone unit located on the other end of the vehicle, in which each drone unit includes a sensor unit configured to measure a gradient traveling environment of the vehicle, a driving unit configured to apply a driving force of the vehicle, and a control unit configured to control driving amounts of the first drone unit and the second drone unit in response to the gradient traveling environment of the vehicle.

Further, the driving unit includes a fuel cell system configured to provide the driving force of the vehicle, a regenerative braking system configured to generate electric energy in a braking environment of the vehicle, and a high-voltage battery electrically conducted with the fuel cell system or the regenerative braking system.

Further, the control unit drives the regenerative braking system of the first drone unit and the regenerative braking system of the second drone unit up to a region where a state of charge (SOC) value of the high-voltage battery becomes the maximum SOC value in a downhill condition as a result of determining the gradient traveling environment of the vehicle.

Further, the control unit is configured to carry out downhill traveling using a mechanical braking apparatus if the high-voltage battery of each drone unit has the maximum SOC value.

Further, the control unit is configured to apply the driving force of the vehicle through a drone unit having a small average value of the driving amount of the drone units in a flatland condition as a result of determining the gradient traveling environment of the vehicle.

Further, the control unit is configured to apply the driving force of the vehicle through a drone unit not selected if a time at which the driving force of the vehicle is applied through a selected drone unit is larger than a setting time.

Further, the control unit is configured to apply a main driving force of the vehicle through a drone unit having a small average value of the driving amount of the drone units in an uphill condition as a result of determining the gradient traveling environment of the vehicle, and to apply a sub driving force of the vehicle through a drone unit having a larger average value of the driving amount.

Further, as another exemplary embodiment of the present disclosure, a method for controlling a driving of a drone unit includes measuring a gradient traveling environment of a vehicle, measuring an average driving amount of a first drone unit and a second drone unit if it is determined that a vehicle is in a flatland condition traveling situation in the measuring of the gradient traveling environment of the vehicle, determining whether a measured cumulative driving amount of the first drone unit is smaller than the measured average driving amount of the first drone unit and the second drone unit, and setting the vehicle to be driven through the first drone unit if the cumulative driving amount of the first drone unit is smaller than the measured average driving amount of the first drone unit and the second drone unit.

Further, the determining of whether the measured cumulative driving amount of the first drone unit is smaller than the measured average driving amount of the first drone unit and the second drone unit further includes setting the vehicle to be driven through the second drone unit if the cumulative driving amount of the first drone unit is larger than the measured average driving amount of the first drone unit and the second drone unit.

Further, the setting of the vehicle to be driven through the first drone unit further includes setting the vehicle to be driven through the second drone unit if a driving time of the first drone unit is larger than a setting time.

Further, the measuring of the gradient traveling environment of the vehicle includes measuring the average driving amount of the first drone unit and the second drone unit if it is determined that the vehicle is in an uphill condition traveling situation, determining whether a measured cumulative driving amount of the first drone unit is smaller than the measured average driving amount of the first drone unit and the second drone unit, and setting the first drone unit as a main driving unit and setting the second drone unit as a sub driving unit if the measured cumulative driving amount of the first drone unit is smaller than the measured average driving amount of the first drone unit and the second drone unit and setting the second drone unit as the main driving unit and setting the first drone unit as the sub driving unit if the measured cumulative driving amount of the first drone unit is larger than the measured average driving amount of the first drone unit and the second drone unit.

Further, the setting of the main driving unit and the sub driving unit includes determining whether a driving amount of the main driving unit is smaller than a setting driving amount, and if the driving amount of the main driving unit is larger than the setting driving amount, the sub driving unit and the main driving unit are configured to be switched.

Further, the measuring of the gradient traveling environment of the vehicle includes measuring an SOC of each drone unit if it is determined that the vehicle is in a downhill condition traveling situation, determining whether the measured SOC value of each drone unit is smaller than the maximum SOC capacity, and carrying out a mechanical braking if the measured SOC value of each drone unit is larger than the maximum SOC capacity.

Further, the determining of whether the measured SOC value of each drone unit is smaller than the maximum SOC capacity includes carrying out a regenerative braking of a drone unit having the measured SOC value smaller than the maximum SOC capacity if the measured SOC value of each drone unit is smaller than the maximum SOC capacity.

Further, the carrying out of the regenerative braking of the drone unit having the measured SOC value smaller than the maximum SOC capacity further includes providing an additional braking force required upon downhill traveling through a mechanical braking.

Embodiments of the present disclosure may obtain the following effects through the present exemplary embodiment and the configuration, coupling, and use relationship to be described later.

Embodiments of the present disclosure can selectively drive the fuel cell system in response to the gradient traveling environment, thereby increasing durability of the fuel cell system mounted on the drone unit.

Further, embodiments of the present disclosure can selectively drive the driving system located on the drone unit in response to each gradient traveling environment, thereby increasing the driving efficiency of the driving system.

It is understood that the term “vehicle,” “automotive” or “vehicular” or other similar term as used herein is inclusive of motor vehicles in general such as passenger automobiles including sport utility vehicles (SUVs), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of embodiments of the disclosure are discussed infra.

### BRIEF DESCRIPTION OF THE DRAWINGS

The above and other features of embodiments of the present disclosure will now be described in detail with reference to certain exemplary examples thereof illustrated in the accompanying drawings which are given herein below by way of illustration only, and thus are not limitative of the present disclosure, and wherein:

FIG. 1 shows a configuration diagram of a driving distribution apparatus of a drone unit as an exemplary embodiment of the present disclosure.

FIG. 2 shows a configuration diagram of an individual drone unit of the driving distribution apparatus of the drone unit as an exemplary embodiment of the present disclosure.

FIG. 3 shows a flowchart in a flatland condition traveling situation of a method for controlling a driving of the drone unit as an exemplary embodiment of the present disclosure.

FIG. 4 shows a flowchart in an uphill condition traveling situation of the method for controlling the driving of the drone unit as an exemplary embodiment of the present disclosure.

FIG. 5 shows a flowchart in a downhill condition traveling situation of the method for controlling the driving of the drone unit as an exemplary embodiment of the present disclosure.

It should be understood that the appended drawings are not necessarily to scale, presenting a somewhat simplified representation of various preferred features illustrative of the basic principles of the disclosure. The specific design features of embodiments of the present disclosure as disclosed herein, including, for example, specific dimensions, orientations, locations, and shapes will be determined in section by the particular intended application and use environment.

In the figures, reference numbers refer to the same or equivalent sections of the present disclosure throughout the several figures of the drawing.

### DETAILED DESCRIPTION OF ILLUSTRATIVE EMBODIMENTS

Hereinafter, exemplary embodiments of the present disclosure will be described in more detail with reference to the accompanying drawings. The exemplary embodiments of the present disclosure can be modified in various forms, and the scope of the present disclosure should not be construed as being limited to the following exemplary embodiments. The present exemplary embodiments are provided to explain the present disclosure to those skilled in the art more fully.

Further, the terms such as “ . . . system”, “ . . . unit”, and “ . . . battery” described in the specification refer to a unit that processes at least one function or operation, which can be implemented by hardware, software, or a combination of hardware and software.

Further, in the present specification, the reason why the names of the components are divided into the first, the second, etc. is to distinguish the names of the components having the same relationship, and the components are not necessarily limited to the order thereof in the following description.

Further, in the present specification, the ‘driving amount’ can refer to an output amount delivered to a vehicle through a fuel cell system 111, and the output (KWh) refers to a unit of indicating a power used (KW) that is delivered to the vehicle through the fuel cell system 111 for a predetermined time.

Hereinafter, the exemplary embodiments will be described in detail with reference to the accompanying drawings, and in describing the exemplary embodiments with reference to the accompanying drawings, the same or corresponding components are denoted by the same reference numerals and a redundant description thereof will be omitted.

Embodiments of the present disclosure relate to a driving distribution apparatus of a drone unit 100 and a method for controlling the same, and each drone unit 100 refers to a vehicle that carries out autonomous traveling, including the fuel cell system 111, and is configured to apply a driving force of a vehicle. Furthermore, as an exemplary embodiment of the present disclosure, technical characteristics of a vehicle including a first drone unit 100a and a second drone unit 100b are disclosed, but the driving distribution apparatus of the drone unit 100 and the method for controlling the same according to embodiments of the present disclosure can also be applied to a vehicle including two or more drone units 100.

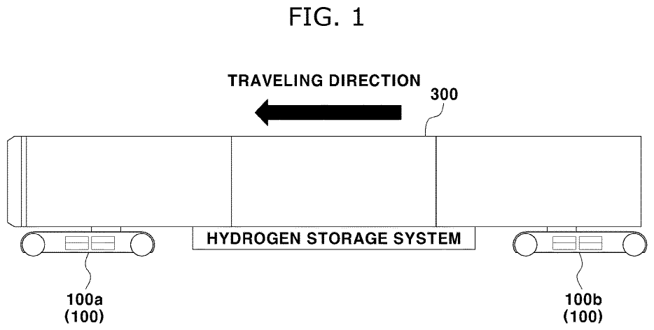

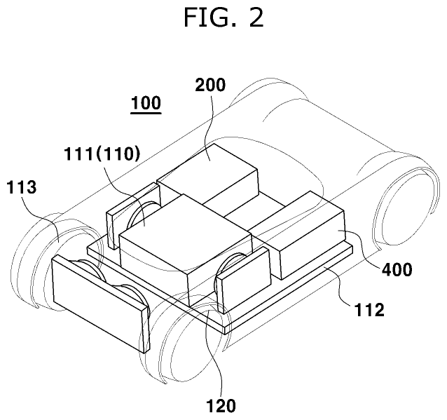

FIG. 1 shows a driving distribution apparatus of the drone unit 100 of a commercial vehicle including the first drone unit 100a and the second drone unit 100b as an exemplary embodiment of the present disclosure, and FIG. 2 shows a configuration of each drone unit 100.

As shown, a commercial vehicle including a storage unit 300 includes the first drone unit 100a fastened to a location close to one end of a front of the vehicle in a longitudinal direction thereof, and includes the second drone unit 100b fastened to a location close to the other end of the vehicle. The drone units 100 can be fastened to a chassis frame and located on a lower end of the storage unit 300, and the corresponding drone units 100 can be configured to be selectively attached to and detached from the storage unit 300.

The drone unit 100 can be configured to apply the driving force of the vehicle through the fuel cell system 111, and can also apply the driving force using a high-voltage battery 112 capable of charging and discharging.

As one of the driving units 110 according to embodiments of the present disclosure, the fuel cell system 111 includes a fuel cell stack, a compressor configured to compress air to supply the compressed air to a cathode of the fuel cell stack, and a hydrogen storage tank located in the storage unit 300 and configured to supply hydrogen to an anode of the fuel cell stack, and includes an exhaust system including a back pressure adjustment valve installed on a line through which the air is discharged after completing the reaction in the fuel cell stack.

Furthermore, an inlet through which the air flows into the fuel cell stack through the compressor can include a regulator configured to reduce the pressure of the compressed air and a cooler capable of controlling the amount and temperature of moisture included in the introduced air.

A control unit 200 can set a flow volume of the air supplied to the fuel cell stack, and control a driving of the compressor based on a current air supply pressure and an amount of required air of the compressor in response to a set flow volume of the air.

Further, the fuel cell system 111 can further include a flow volume sensor and a pressure sensor configured to detect the flow volume and pressure of the air supplied from the compressor fluid-connected to the fuel cell stack according to the exemplary embodiment of the present disclosure, respectively.

As the other component of the driving unit 110 of the drone unit 100 according to the present disclosure, the high-voltage battery 112 can be fastened to the fuel cell stack to receive electric energy from the fuel cell stack. Alternatively, the high-voltage battery 112 can be located in each drone unit 100 to be electrically conducted with a regenerative braking system 113 of the corresponding drone unit 100. Therefore, the high-voltage battery 112 can be selectively charged by the fuel cell stack or the regenerative braking system 113.

In other words, as the driving unit no according to embodiments of the present disclosure, the fuel cell system 111 and the high-voltage battery 112 refer to components capable of applying the driving force of the vehicle. Further, the driving unit no is a braking system of the vehicle, and the regenerative braking system 113 includes a component electrically conducted with the high-voltage battery 112.

The control unit 200 is configured to measure the gradient traveling environment of the vehicle through a sensor unit 120 mounted on the vehicle. In other words, the sensor unit 120 can be formed of an acceleration sensor, and can measure a change in acceleration in the gradient traveling environment of the vehicle, and the control unit 200 can determine an uphill traveling condition, a flatland traveling condition, and a downhill traveling condition of the vehicle in response to the change in acceleration.

More specifically, the control unit 200 can determine the traveling condition by measuring a wheel angular velocity with a feedback value for a required output value set by the control unit 200 using a method for determining the gradient traveling environment of the vehicle through an acceleration sensor.

In other words, if a constant required output is applied to the vehicle, the wheel angular velocity can vary depending upon the flatland/uphill/downhill conditions as the gradient traveling environment. For example, the required output of 40 kW is required to allow the vehicle to reach 100 km/h in a stopped state, and when the wheel angular velocity is measured at about 54.9 rad/s (based on the tire radius of 506 mm [315/70R22.5] in a vehicle to which the corresponding required output is applied, it can be determined as the flatland condition. In contrast, the wheel angular velocity lower than that of the flatland traveling condition is measured in the uphill traveling condition, and a low velocity is applied even in a case where the same output is applied. Furthermore, a high velocity value is measured in the downhill traveling condition even in a case where a high wheel angular velocity and the same output are applied.

In conclusion, in determining the gradient traveling environment of the vehicle, the control unit 200 determines a case where the wheel angular velocity increases as the downhill traveling condition, and a case where the wheel angular velocity decreases as the uphill traveling condition using the wheel angular velocity in the flatland traveling condition as a reference value.

Hereinafter, a method for distributing the driving force to each drone unit 100 by the control unit 200 depending upon each gradient condition will be described.

The control unit 200 can determine that the vehicle is in the flatland condition traveling situation by the wheel angular velocity measured by the sensor unit 120. In case of being determined as the flatland condition traveling situation, a step of measuring an average driving amount of the first drone unit 100a and the second drone unit 100b and comparing the measured average driving amount with a cumulative driving amount of the first drone unit 100a is carried out.

Here, the average driving amount of the first drone unit 100a and the second drone unit 100b is calculated by dividing the product of an output generated by each drone unit 100 and an operation time thereof into the number of drone units 100. In other words, the vehicle including multiple drone units 100 calculates the output (KWh) through the entire driving to divide the calculated output into the number of drone units 100 to calculate the output applied to each drone unit 100 as the average driving amount.

Further, the cumulative driving amount is the output (KWh) generated for an operation time of each drone unit 100, and the control unit 200 measures the cumulative driving amount of each drone unit 100.

By comparing the thus calculated cumulative driving amount of the first drone unit 100a with the average driving amount of the first drone unit 100a and the second drone unit 100b, if the cumulative driving amount of the first drone unit 100a is smaller than the average driving amount of the first drone unit 100a and the second drone unit 100b, the control unit 200 determines to allow the vehicle to be driven through the first drone unit 100a. In contrast, if the cumulative driving amount of the first drone unit 100a is larger than the average driving amount of the first drone unit 100a and the second drone unit 100b, the control unit 200 determines to allow the vehicle to be driven through the second drone unit 100b.

Furthermore, the control unit 200 sets the driving relationship to carry out the driving using another drone unit 100 if the drone unit 100 determined as carrying out the driving has a driving time larger than a setting time. In other words, if the setting time elapses after it is determined to provide the driving force in the flatland traveling through the first drone unit 100a, the control unit 200 switches the driving relationship to provide the driving force using the second drone unit 100b. In contrast, if the setting time elapses after it is determined to provide the driving force in the flatland traveling through the second drone unit 100b, the control unit 200 switches the driving relationship to provide the driving force using the first drone unit 100a.

Therefore, different drone units 100 are alternately controlled to apply the driving force such that the heavy driving situation is not set through one drone unit 100.

As another gradient traveling environment according to embodiments of the present disclosure, a case where the control unit 200 determines it as the uphill condition traveling situation will be described.

If it is determined that the vehicle is in the uphill condition traveling situation by a wheel acceleration value measured by the sensor unit 120, the control unit 200 measures the average driving amount of the first drone unit 100a and the second drone unit 100b, and determines whether the measured cumulative driving amount of the first drone unit 100a is smaller than the measured average driving amount of the first drone unit 100a and the second drone unit 100b.

Here, if the measured cumulative driving amount of the first drone unit 100a is smaller than the measured average driving amount of the first drone unit 100a and the second drone unit 100b, the control unit 200 sets the first drone unit 100a as a main driving unit and sets the second drone unit 100b as a sub driving unit, and if the measured cumulative driving amount of the first drone unit 100a is larger than the measured average driving amount of the first drone unit 100a and the second drone unit 100b, the control unit 200 sets the second drone unit 100b as the main driving unit and sets the first drone unit 100a as the sub driving unit.

The main driving unit refers to the drone unit 100 set to have a driving amount relatively higher than that of the sub driving unit, and the control unit 200 controls both the first drone unit 100a and the second drone unit 100b to be driven such that the total driving amount relatively higher than that of the flatland traveling can be applied due to the uphill traveling.

According to an exemplary embodiment of the present disclosure, the main driving unit can be controlled to be in charge of the output of 60 to 80% of the required output, and the sub driving unit can be controlled to be in charge of the output of 20 to 40% of the required output. Furthermore, the output of the main driving unit and the output of the sub driving unit can be differently set by a slope and a traveling velocity.

As described above, after the main driving unit and the sub driving unit are determined, if the driving amount of the main driving unit is larger than a setting driving amount stored in the control unit 200, the main driving unit and the sub driving unit are configured to be switched to each other. In other words, after the first determined main driving unit and sub driving unit are driven for a predetermined time, if the driving amount of the main driving unit is larger than the setting driving amount, the sub driving unit is configured to be switched to be the main driving unit, and the previously set main driving unit is configured to be switched to be the sub driving unit in order to prevent overdriving.

The setting driving amount can be set as a value obtained by adding a predetermined setting value to the average driving amount of the first drone unit 100a and the second drone unit 100b, and according to an exemplary embodiment of the present disclosure, the setting value can be 100 KWh.

As still another gradient traveling environment according to embodiments of the present disclosure, a case where the control unit 200 determines it as the downhill condition traveling situation will be described.

The downhill condition traveling situation is a situation where the driving force of the vehicle is not required and the driving of the regenerative braking system 113 or the driving of a mechanical braking apparatus 400 is required to brake the sudden acceleration of the vehicle.

If it is determined that the vehicle is in the downhill condition traveling situation, the control unit 200 is configured to measure the SOC of each drone unit 100, and compare the measured SOC with the maximum SOC capacity. This is a component that is converted into electric energy through the regenerative braking system 113 to determine the SOC capacity capable of being charged in the high-voltage battery 112. Therefore, through such a determination, it is determined to calculate a required charging amount by a difference between the maximum SOC capacity and a current SOC of each drone unit 100, and drive the regenerative braking system 113 in response to the required charging amount.

Additionally, if a braking force larger than the driving force of the regenerative braking system 113 is required in the downhill condition traveling situation, the braking of the vehicle is configured to be carried out using the mechanical braking apparatus by the difference between the required braking amount and the regenerative braking amount.

More specifically, the control unit 200 measures the current SOC of the high-voltage battery 112 of the first drone unit 100a, determines that the charging is available up to the maximum SOC capacity, and measures the current SOC of the high-voltage battery 112 of the second drone unit 100b to determine that the charging is available up to the maximum SOC capacity. Therefore, the braking is carried out using the regenerative braking system 113 of the first drone unit 110a and the regenerative braking system 113 of the second drone unit 100b in response to determining that the charging is available up to the maximum SOC capacity. Further, as a comparison result, if the braking force provided to the vehicle through the regenerative braking system 113 is smaller than the braking force required by the control unit 200, the additionally required braking force is provided to the vehicle through the mechanical braking apparatus 400.

If the current SOC of each drone unit 100 measured by the control unit 200 is equal to or larger than the maximum SOC capacity, only the mechanical braking apparatus 400 is configured to be driven to apply the braking force to the vehicle without driving the regenerative braking system 113 of the drone unit 100 in which the SOC having the maximum SOC capacity or more is measured.

As described above, embodiments of the present disclosure are configured such that the control unit 200 measures the gradient traveling environment, determines the flatland condition traveling situation, the uphill condition traveling situation, and the downhill condition traveling situation to control the driving amounts of the fuel cell systems 111 of the first drone unit 100a and the second drone unit 100b, and furthermore, the control unit 200 is configured to control the driving of the regenerative braking system 113 in consideration of the SOC of the high-voltage battery 112 in response to the downhill condition traveling situation of the vehicle.

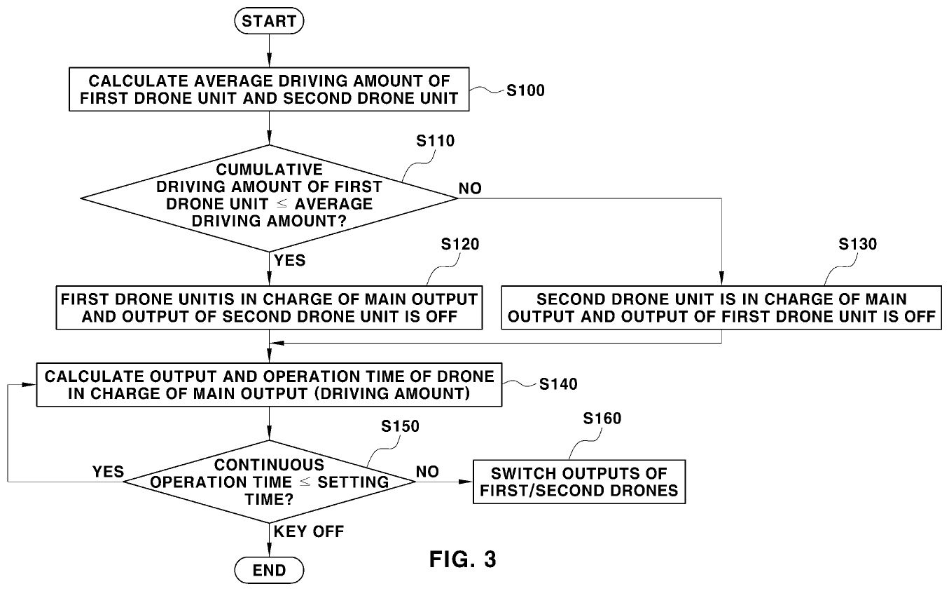

FIG. 3 shows a method for controlling the driving amount of the vehicle that is in the flatland condition traveling situation, as an exemplary embodiment of the present disclosure.

First, the control unit 200 is configured to determine the gradient traveling environment of the vehicle based on the data received from the sensor unit 120. The gradient traveling environment is measured by a wheel angular velocity sensor, and is determined as the uphill condition traveling situation if the wheel angular velocity measured by applying the same required output to the vehicle is smaller than the set wheel angular velocity based on the wheel angular velocity set in the flatland traveling as a comparison result, and is determined as the downhill condition traveling situation if the measured wheel angular velocity is larger than the set wheel angular velocity as a comparison result.

If the control unit 200 determines the gradient traveling environment of the vehicle as the flatland condition traveling situation, the average driving amount applied to the first drone unit 100a and the second drone unit 100b is measured (S100). In this step, the average driving amount can be calculated by summing the outputs (KWh) of the first drone unit 100a and the second drone unit 100b to divide the summed output into the number of drone units 100.

A step of calculating the average driving amount and then comparing the calculated average driving amount with the cumulative driving amount of the first drone unit 100a is carried out (S110). If the cumulative driving amount of the first drone unit 100a is smaller than or equal to the average driving amount applied to the first drone unit 100a and the second drone unit 100b (YES at S110), the driving output is provided to the vehicle through the fuel cell system 111 of the first drone unit 100a to allow the vehicle to be driven through the first drone unit 100a (S120).

In contrast, if the cumulative driving amount of the first drone unit 100a is larger than the average driving amount applied to the first drone unit 100a and the second drone unit 100b (NO at S110), the driving output is applied to the vehicle through the fuel cell system 111 of the second drone unit 100b (S130).

In other words, the control unit 200 drives the vehicle according to the flatland condition traveling situation through the drone unit 100 having a relatively low cumulative driving amount by determining the driving amount of the first drone unit 100a and the driving amount of the second drone unit 100b until now.

The flatland condition traveling is carried out through the drone unit 100 having the thus selected relatively low cumulative driving amount, then the output and operation time of the drone in charge of the main output are calculated (S140). The continuous operation time is compared to a setting time (S150). If it is determined that the vehicle continuously travels for the setting time or less (YES at S150), the output and operation time of the drone in charge of the main output is calculated again (S140), and if it is determined that the vehicle continuously travels for more than setting time (NO at S150), the control unit 200 controls the vehicle to be driven through the drone unit 100 not selected previously (S160).

Therefore, it is possible to prevent the long-term use using one drone unit 100, thereby improving durability of the fuel cell system 111 of the drone unit 100.

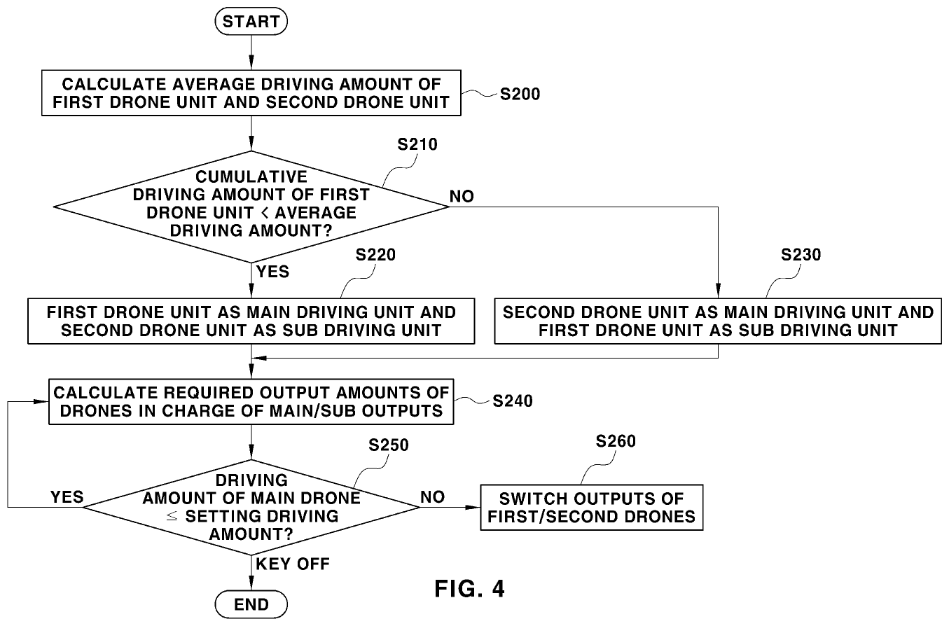

FIG. 4 shows a method for controlling the driving of the drone unit 100 of the vehicle upon uphill condition traveling, as an exemplary embodiment of the present disclosure.

The control unit 200 first determines the gradient traveling environment of the vehicle based on the wheel angular velocity data measured by the sensor unit 120, and if it is determined that the vehicle is in the uphill condition traveling situation, the average driving amount of the first drone unit 100a and the second drone unit 100b is measured (S200).

By being compared with the cumulative driving amount of the first drone unit 100a based on the thus measured average driving amount of the first drone unit 100a and the second drone unit 100b (S210), if the cumulative driving amount of the first drone unit 100a is smaller than the average driving amount of the first drone unit 100a and the second drone unit 100b (YES at S210), the first drone unit 100a is set as the main driving unit and the second drone unit 100b is set as the sub driving unit (S220).

In contrast, if the cumulative driving amount of the first drone unit 100a is larger than the average driving amount of the first drone unit 100a and the second drone unit 100b (NO at S210), the second drone unit 100b is set as the main driving unit and the first drone unit 100a is set as the sub driving unit (S230).

In other words, since the vehicle has an increased required output in response to the required velocity in the uphill condition traveling environment, the first drone unit 100a and the second drone unit 100b are configured to be simultaneously driven to correspond to the required output, and the main driving unit and the sub driving unit are set to provide the driving force of the vehicle through multiple drone units 100.

As described above, the required output amounts of the main driving unit and the sub driving unit are calculated after the main driving unit and the sub driving unit are set (S240). If the driving amount of the main driving unit is less than or equal to the setting driving amount stored in the control unit 200 (YES at S250), the required output amounts of the main driving unit and the sub driving unit are calculated again (S240), and if the driving amount of the main driving unit is larger than the setting driving amount stored in the control unit 200 (NO at S250), the sub driving unit and the main driving unit are configured to be switched (S260). In other words, after the first drone unit 100a is set as the main driving unit and the second drone unit 100b is set as the sub driving unit, if the driving amount after the first drone unit 100a is set as the main driving unit is larger than the setting driving amount, a control of switching the second drone unit 100b to the main driving unit and switching the first drone unit 100a to the sub driving unit is carried out.

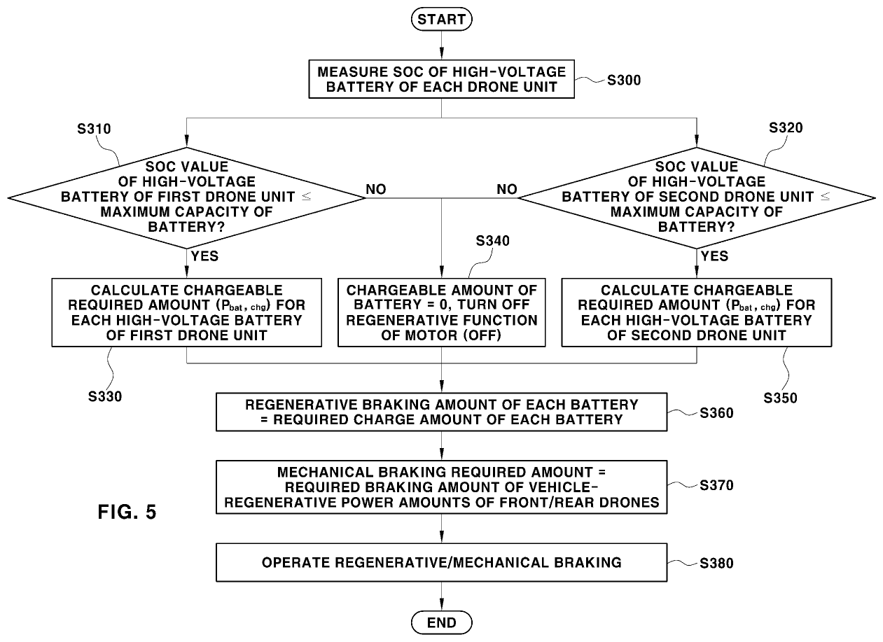

FIG. 5 shows the method for controlling the driving of the drone unit 100 upon downhill condition traveling of the vehicle according to an exemplary embodiment of the present disclosure.

If it is determined that the vehicle is in the downhill condition traveling situation by the wheel angular velocity measured by the sensor unit 120, the SOC of the high-voltage battery 112 located on each drone unit 100 is measured (S300).

The method includes steps of comparing the SOC value of the high-voltage battery 112 of the first drone unit 100a and the SOC value of the high-voltage battery 112 of the second drone unit 100b that are thus measured with the maximum SOC capacity stored in the control unit 200 (S310, S320).

In the comparing steps, the control unit 200 determines whether the SOC measured value of each drone unit 100 is smaller than or equal to the maximum SOC capacity (S310, S320), and if the measured SOC value of each drone unit 100 is larger than the maximum SOC capacity (NO at S310, S320), the control unit 200 controls the driving of the regenerative braking system 113 to be switched to an OFF state and controls the mechanical braking to be carried out (S340).

In contrast, if the measured SOC value of at least one drone unit 100 of the respective drone units 100 is smaller than or equal to the maximum SOC capacity (YES at S310, S320), the control unit 200 drives the regenerative braking system 113 of the drone unit 100 having the measured value smaller than or equal to the maximum SOC capacity and calculates the chargeable required amount for each high-voltage battery of the respective first or second drone unit (S330, S350). In other words, whether the SOC charging of the high-voltage battery 112 is currently available is determined, and the high-voltage battery 112 is charged through the regenerative braking by driving the regenerative braking system 113 (S360).

Additionally, the mechanical braking required amount equals the required breaking amount of the vehicle less the regenerative power amounts of the first and second drone units (S370), and the mechanical braking is configured to be carried out to provide the braking force required for the vehicle (S380).

As described above, the control unit 200 includes the determination of charging the electric energy capable of being generated from the regenerative braking system 113 due to the downhill traveling in the high-voltage battery 112 and preventing the overcharging state of the high-voltage battery 112. Further, it is possible to extend the life of the mechanical braking apparatus by minimizing the use of the mechanical braking.

The aforementioned detailed description is to exemplify embodiments of the present disclosure. Further, the aforementioned contents show and describe the preferred exemplary embodiments of the present disclosure, and the present disclosure can be used in various other combinations, changes, and environments. In other words, changes or modifications can be made without departing from the scope of the concept of the disclosure disclosed in the present specification, the scope equivalent to the described and disclosed contents, and/or the scope of the technology or knowledge in the art. The described exemplary embodiments describe the best mode for implementing the technical spirit of the present disclosure, and various changes thereof required in the specific application field and use of the present disclosure can also be made. Therefore, the aforementioned detailed description is not intended to limit the present disclosure to the disclosed exemplary embodiments. Further, the appended claims should be construed as also including other exemplary embodiments.

What is claimed is:

1. A driving distribution apparatus of a drone unit, the driving distribution apparatus comprising:
a first drone unit located on a first end of a vehicle; and
a second drone unit located on a second end of the vehicle, wherein each of the first and second drone units comprises:
a sensor unit configured to measure a gradient traveling environment of the vehicle;
a driving unit configured to apply a driving force of the vehicle; and
a control unit configured to control driving amounts of the first drone unit and the second drone unit based on the gradient traveling environment of the vehicle.

2. The driving distribution apparatus of claim 1, wherein the driving unit comprises:
a fuel cell system configured to provide the driving force of the vehicle;
a regenerative braking system configured to generate electric energy in a braking environment of the vehicle; and
a high-voltage battery electrically conducted with the fuel cell system or the regenerative braking system.

3. The driving distribution apparatus of claim 2, wherein the gradient traveling environment of the vehicle is a downhill condition, and wherein the control unit is configured to drive the regenerative braking system of the first drone unit and the regenerative braking system of the second drone unit up to a region where a state of charge (SOC) value of the high-voltage battery becomes a maximum SOC value in the downhill condition.

4. The driving distribution apparatus of claim 3, wherein the control unit is configured to carry out downhill traveling using a mechanical braking apparatus when the high-voltage battery of each drone unit has the maximum SOC value.

5. The driving distribution apparatus of claim 1, wherein the gradient traveling environment of the vehicle is a flatland condition, and wherein the control unit is configured to apply the driving force of the vehicle through a selected one of the first or second drone unit that has a smaller average value of the driving amounts of the first and second drone units in the flatland condition.

6. The driving distribution apparatus of claim 5, wherein the control unit is configured to apply the driving force of the vehicle through an unselected one of the first or second drone unit in response to a time at which the driving force of the vehicle is applied through the selected one of the first or second drone unit being larger than a setting time.

7. The driving distribution apparatus of claim 1, wherein the gradient traveling environment of the vehicle is an uphill condition, and wherein the control unit is configured to apply a main driving force of the vehicle through the drone unit having a smaller average value of the driving amounts of the first and second drone units and to apply a sub driving force of the vehicle through the drone unit having a larger average value of the driving amounts of the first and second drone units.

8. A method for controlling driving of a drone unit, the method comprising:
determining a gradient traveling environment of a vehicle as a flatland condition traveling situation or an uphill condition traveling situation;
measuring an average driving amount of a first drone unit and a second drone unit;
measuring a cumulative driving amount of the first drone unit;
determining whether the cumulative driving amount of the first drone unit is smaller than the average driving amount of the first drone unit and the second drone unit; and
in response to determining the gradient traveling environment as the flatland condition traveling situation and determining that the cumulative driving amount of the first drone unit is smaller than the average driving amount of the first drone unit and the second drone unit, setting the vehicle to be driven through the first drone unit.

9. The method of claim 8, wherein, in response to determining the gradient traveling environment as the flatland condition traveling situation and determining that the cumulative driving amount of the first drone unit is larger than the average driving amount of the first drone unit and the second drone unit, setting the vehicle to be driven through the second drone unit.

10. The method of claim 8, further comprising:
determining whether a driving time of the first drone unit is larger than a setting time; and
setting the vehicle to be driven through the second drone unit in response to a determination that the driving time of the first drone unit is larger than the setting time.

11. The method of claim 8, further comprising:
in response to determining the gradient traveling environment as the uphill condition traveling situation and determining that the cumulative driving amount of the first drone unit is smaller than the average driving amount of the first drone unit and the second drone unit, setting the first drone unit as a main driving unit and setting the second drone unit as a sub driving unit; or
in response to determining the gradient traveling environment as the uphill condition traveling situation and determining that the cumulative driving amount of the first drone unit is larger than the average driving amount of the first drone unit and the second drone unit, setting the second drone unit as the main driving unit and setting the first drone unit as the sub driving unit.

12. The method of claim 11, further comprising:
determining whether a driving amount of the main driving unit is smaller than a setting driving amount; and
in response to a determination that the driving amount of the main driving unit is larger than the setting driving amount, switching the sub driving unit and the main driving unit.

13. The method of claim 8, wherein the first drone unit is located on a first end of the vehicle and the second drone unit located on a second end of the vehicle, and wherein each of the first and second drone units comprises:
a sensor unit that measures the gradient traveling environment of the vehicle;
a driving unit that applies a driving force of the vehicle; and
a control unit that controls driving amounts of the first drone unit and the second drone unit based on the gradient traveling environment of the vehicle.

14. The method of claim 13, wherein the driving unit comprises:
a fuel cell system that provides the driving force of the vehicle;
a regenerative braking system that generates electric energy in a braking environment of the vehicle; and
a high-voltage battery that is electrically conducted with the fuel cell system or the regenerative braking system.

15. A method for controlling driving of a drone unit, the method comprising:
determining a gradient traveling environment of a vehicle as a downhill condition traveling situation;
measuring a state of charge (SOC) of at least one drone unit;
determining whether the SOC of the drone unit is smaller than a maximum SOC capacity; and
carrying out a mechanical braking in response to a determination that the SOC of the drone unit is larger than the maximum SOC capacity.

16. The method of claim 15, further comprising carrying out a regenerative braking of the drone unit in response to a determination that the SOC of the drone unit is smaller than the maximum SOC capacity.

17. The method of claim 16, further comprising providing an additional braking force required upon downhill traveling through a mechanical braking.

18. The method of claim 15, wherein the at least one drone unit comprises a first drone unit located on a first end of the vehicle and a second drone unit located on a second end of the vehicle, and wherein each of the first and second drone units comprises:
a sensor unit that measures the gradient traveling environment of the vehicle;
a driving unit that applies a driving force of the vehicle; and
a control unit that controls driving amounts of the first drone unit and the second drone unit based on the gradient traveling environment of the vehicle.

19. The method of claim 18, wherein the driving unit comprises:
a fuel cell system that provides the driving force of the vehicle;
a regenerative braking system that generates electric energy in a braking environment of the vehicle; and
a high-voltage battery that is electrically conducted with the fuel cell system or the regenerative braking system.
